(19) United States
(12) Patent Application Publication
(10) Pub. No.: US 2026/0330686 A1
(43) Pub. Date: Oct. 22, 2026

(54) ONBOARD CAMERA CALIBRATION DEVICE, METHOD, PROGRAM, AND ONBOARD DEVICE

(71) Applicant: HONDA MOTOR CO., LTD., Tokyo (JP)

(72) Inventors: Hiroyuki Nakashima, Tokyo (JP); Hiroki Oshiyama, Yokohama-shi (JP)

(21) Appl. No.: 19/467,865

(22) Filed: Feb. 3, 2026

(30) Foreign Application Priority Data
Mar. 18, 2025 (JP) 2025-043576

(51) Int. Cl. G06T 7/80; G06T 7/11; G06T 7/50; H04N 17/00

(52) U.S. Cl. CPC G06T 7/80; G06T 7/11; G06T 7/50; H04N 17/002; G06T 2207/30252

(57) ABSTRACT

An onboard camera calibration device includes an image acquisition part and a parameter calculation part. The image acquisition part acquires an image, of an imaging object for measuring a correction amount of a captured image, captured by a camera provided behind a glass. The parameter calculation part calculates, based on an acquired image of the imaging object, a parameter value of a coordinate correction function for correcting an image captured by the camera, in which the coordinate correction function is set on the premise that a depth from the camera to a subject is sufficiently larger than a depth from the camera to the glass.

### CROSS-REFERENCE TO RELATED APPLICATION

Priority is claimed on Japanese Patent Application No. 2025-043576, filed Mar. 18, 2025, the content of which is incorporated herein by reference.

### BACKGROUND OF THE INVENTION

### Field of the Invention

The present invention relates to an onboard camera calibration device, a method, a program, and an onboard device.

### Description of Related Art

In order to further improve traffic safety and convenience, research and development has been progressing in advanced driver-assistance systems (ADAS) enabling vehicles to recognize surrounding conditions using various sensors to provide a driver with accurate situational displays and warnings. Onboard cameras are regarded as one of the essential sensors for such systems.

For example, there are known vehicles configured to recognize objects and the like outside the vehicle based on images captured by an onboard camera and to execute driving assistance control based on the recognition results. In order to utilize images captured by an onboard camera for driving assistance control in this manner, the captured images of the onboard camera are required to be free from distortion. Hence, technologies for calibrating onboard cameras have been developed.

Patent Document 1 (specification of U.S. Pat. No. 8,885,049) discloses a technology for determining calibration parameters by capturing a first image of an object and a second image of the object, and determining a conversion adapted to convert a portion of the first image into a corresponding portion of the second image.

### SUMMARY OF THE INVENTION

Incidentally, an onboard camera is installed inside a vehicle from the viewpoint of protection against influences of the external environment, such as rain and dust, and colliding objects. In this case, images captured by the onboard camera become images including distortion due to the influence of refraction of light caused by a glass in front of the onboard camera, for example, a windshield when the onboard camera is provided on the front side inside the vehicle.

The present invention has been made in consideration of such circumstances, and an object thereof is to provide an onboard camera calibration device, a method, a program, and an onboard device capable of calibrating a captured image in consideration of distortion caused by a glass when an onboard camera captures an image of the outside of a vehicle through a windshield.

A calibration device, a method, a program, and an onboard device according to this invention employ the following configurations.
(1): A calibration device according to an aspect of this invention includes an image acquisition part acquiring an image, of an imaging object for measuring a correction amount of a captured image, captured by a camera provided behind a glass; and a parameter calculation part calculating, based on an acquired image of the imaging object, a parameter value of a coordinate correction function for correcting an image captured by the camera, in which the coordinate correction function is set on the premise that a depth from the camera to a subject is sufficiently larger than a depth from the camera to the glass.
(2): In the foregoing aspect (1), in a case where a field of view from the camera to a subject when the glass is not present is able to be approximated by an angle obtained by subtracting an angle change due to refraction of light at the glass from an observed field of view of the subject from the camera, the depth from the camera to a subject may be sufficiently larger than the depth from the camera to the glass.
(3): In the foregoing aspect (2), when a difference in angle obtained by subtracting the angle change from the observed field of view with respect to the field of view is equal to or smaller than a predetermined value, the field of view from the camera to a subject when the glass is not present may be able to be approximated by an angle obtained by subtracting an angle change due to refraction caused by the glass from an observed angle of the subject by the camera.
(4): In the foregoing aspect (1), the onboard camera calibration device may further include a coordinate correction amount determination part determining a pixel position correction amount due to refraction at the glass using an image of the imaging object. The parameter calculation part may calculate a parameter value of the coordinate correction function using the pixel position correction amount.
(5): In the foregoing aspect (4), the coordinate correction function may be set for each of a horizontal direction and a vertical direction. The parameter calculation part may obtain a parameter value of the coordinate correction function set in advance for each of the horizontal direction and the vertical direction.
(6): In the foregoing aspect (4), the parameter calculation part may calculate a parameter value of the coordinate correction function common to the entire imaging range of the camera.
(7): In the foregoing aspect (4), the parameter calculation part may calculate a parameter value of the coordinate correction function for each of a plurality of regions obtained by dividing the entire imaging range of the camera.
(8): In the foregoing aspect (7), when the correction amount is equal to or smaller than a predetermined value for all pixels within any one of the plurality of regions obtained by dividing the entire imaging range of the camera, the parameter calculation part may perform processing such that pixel position correction in the region is unnecessary.
(9): In the foregoing aspect (1), the imaging object may be a calibration board having a regular geometric pattern.
(10): An onboard device according to another aspect of this invention includes a storage part storing information for coordinate position correction of a captured image calculated by the onboard camera calibration device according to the foregoing aspects (1) to (9), and a correction part performing pixel position correction of a captured image using the information for coordinate position correction.
(11): In the foregoing aspect (10), the information for coordinate position correction may include a parameter value for a coordinate correction function calculated by a calibration device. The correction part may correct a pixel position of a captured image using the coordinate correction function and the parameter value.
(12): In the foregoing aspect (10), the storage part may include a plurality of pieces of the information for coordinate position correction. The correction part May perform pixel position correction of a captured image using the information for coordinate position correction corresponding to a glass provided in front of an onboard camera installed inside a vehicle.
(13): An onboard device according to another aspect of this invention includes a storage part storing a parameter value of a coordinate correction function for correcting an image of scenery captured by a camera through a glass provided in a vehicle to an image of scenery captured by the camera without having the glass therebetween, in which the coordinate correction function is set on the premise that a depth from the camera to a subject is sufficiently larger than a depth from the camera to the glass; and a correction part correcting an image captured by the camera based on the stored parameter value.
(14): A method according to another aspect of this invention is a method for calibrating an onboard camera including acquiring an image, of an imaging object for measuring a correction amount of a captured image, captured by a camera provided behind a glass; and calculating, based on an acquired image of the imaging object, a parameter value of a coordinate correction function for correcting an image captured by the camera, in which the coordinate correction function is set on the premise that a depth from the camera to a subject is sufficiently larger than a depth from the camera to the glass.
(15): A program according to another aspect of this invention is an onboard camera calibration program for causing a computer to execute acquiring an image, of an imaging object for measuring a correction amount of a captured image, captured by a camera provided behind a glass; and calculating, based on an acquired image of the imaging object, a parameter value of a coordinate correction function for correcting an image captured by the camera, in which the coordinate correction function is set on the premise that a depth from the camera to a subject is sufficiently larger than a depth from the camera to the glass.

According to the aspects of (1) to (15), it is possible for the onboard device to correct a captured image using only the coordinate correction function and the determined parameters by calculating, based on an acquired image of an imaging object, a parameter value of the coordinate correction function for correcting an image captured by the camera, in which the coordinate correction function is set on the premise that a depth from the camera to a subject is sufficiently larger than a depth from the camera to the glass.

### BRIEF DESCRIPTION OF THE DRAWINGS

FIG. 1 is a diagram showing an example of a configuration of an onboard camera calibration device according to an embodiment.

FIG. 2 is an explanatory diagram of distortion of an image captured by a front camera caused by a windshield.

FIG. 3A is a diagram showing angle changes due to refraction in a horizontal field-of-view direction.

FIG. 3B is a diagram showing angle changes due to refraction in a vertical field-of-view direction.

FIG. 4 is a flowchart showing operation of the calibration device.

FIG. 5 is a diagram showing an example of a configuration of an onboard camera according to the embodiment.

FIG. 6 is a flowchart showing operation of the onboard camera.

FIG. 7 is a diagram showing amounts of pixel position error before and after correction in the onboard camera provided in a different vehicle of the same vehicle model.

FIG. 8 is a diagram showing an example of division of an imaging range of the onboard camera.

FIG. 9 is a diagram showing another example of division of the imaging range of the onboard camera.

### DETAILED DESCRIPTION OF THE INVENTION

Hereinafter, an embodiment of an onboard camera calibration device and an onboard device according to the present invention will be described with reference to the drawings.

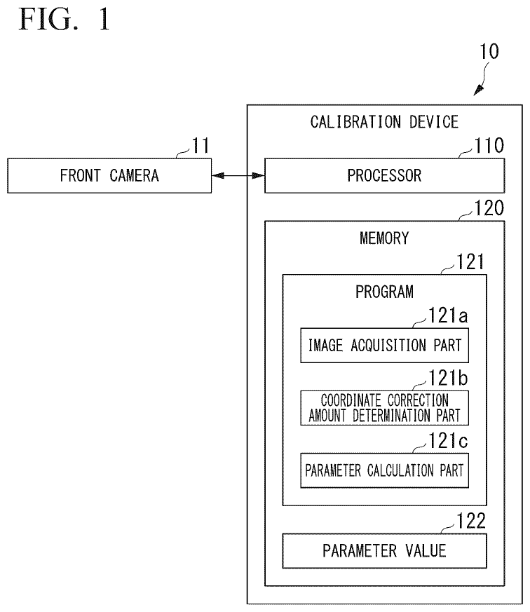

FIG. 1 is a diagram showing a configuration of a calibration device for calibrating an onboard camera. In FIG. 1, the onboard camera will be described as a front camera 11 provided in the vicinity of a windshield inside a vehicle. Hereinafter, not only the front camera 11 but also a camera installed inside the vehicle and provided in the vicinity of a vehicle glass may be collectively referred to as an “onboard camera”. In addition, when an image of the outside of the vehicle is captured by the onboard camera, if the glass of the vehicle in front of the onboard camera is not limited to the windshield, it may be collectively referred to as a “glass”.

A calibration device 10 is constituted of a processor 110 and a memory 120. Here, the memory 120 stores a program 121 for realizing functions of the calibration device 10. The processor 110 realizes the functions of the calibration device 10 by executing the program 121. In addition, the memory 120 also stores a parameter value 122 for calibrating the front camera 11 calculated by executing the program 121.

When the program 121 is executed by the processor 110, the functions of an image acquisition part 121a, a coordinate correction amount determination part 121b, and a parameter calculation part 121c are realized. Here, the image acquisition part 121a acquires an image, of an imaging object for measuring a correction amount of a captured image, captured by the camera provided behind the glass. The coordinate correction amount determination part 121b determines a pixel position correction amount due to refraction at the glass using the image of the imaging object. The parameter calculation part 121c calculates a parameter value of a coordinate correction function for distortion of a captured image based on the pixel position correction amount. In addition, the parameter calculation part 121c stores the obtained parameter value of the coordinate correction function. Here, the coordinate correction function is a function for correcting an image captured by the camera and is a function set on the premise that the depth from the camera to a subject is sufficiently larger than the depth from the camera to the glass.

For example, the parameter calculation part 121c measures a deviation for each pixel by comparing a first image of a target (for example, a calibration board with a honeycomb structure pattern or the like) captured through the glass with a second image of the target captured without having the glass therebetween. For example, the parameter calculation part 121c derives the parameter value of the coordinate correction function minimizing an error based on the measurement results. For example, the parameter calculation part 121c performs nonlinear optimization to minimize a squared error. By performing correction of an image utilizing this coordinate correction function, fitting is performed using a perspective projection model, and a residual error (reprojection error) after fitting of each feature point is sufficiently reduced. Details will be described below.

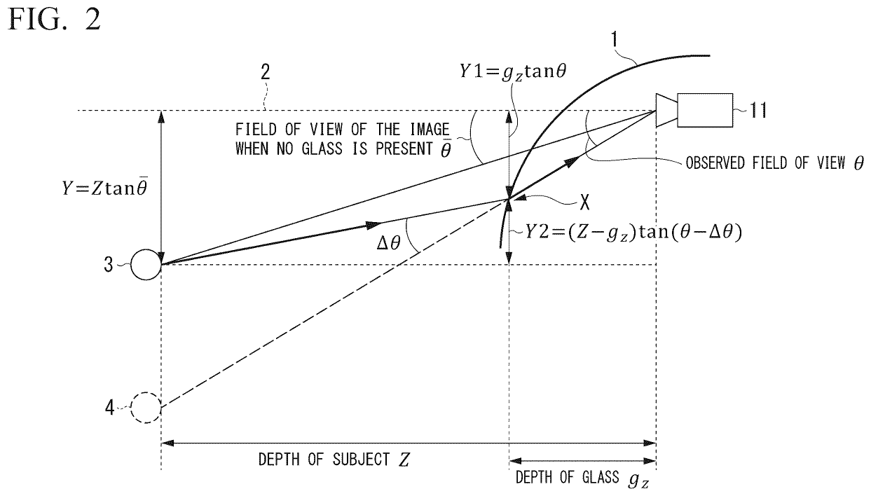

Next, distortion of a captured image when the front camera 11 captures an image of the outside of the vehicle through the windshield, and correction of the distortion of the captured image will be described. FIG. 2 is an explanatory diagram of distortion of an image captured by the front camera 11 caused by a windshield. In FIG. 2, the reference sign 1 indicates a windshield 1 in the vicinity of the front camera 11, the reference sign 2 indicates an optical axis of the front camera 11, and the reference sign 3 indicates a subject outside the vehicle. In addition, the reference sign 4 indicates an observed image of the subject 3 captured by the front camera 11 due to the influence of refraction of light caused by the windshield 1. In FIG. 2, the intersection of the straight line connecting the front camera 11 and the observed image 4 with the windshield 1 will be regarded as “X”. The factor “g_{z}” indicates the depth of the glass, which is the distance in the direction of the optical axis 2 from an imaging position of the front camera 11 to the intersection X. “Z” indicates the depth of the subject, which is the distance in the direction of the optical axis 2 from the imaging position of the front camera 11 to the observed image 4. In addition, the angle formed between the optical axis 2 and the observed image 4, with the imaging position of the front camera 11 as its vertex, is defined as an observed field of view θ. The field of view formed between the optical axis 2 and the subject 3, with the imaging position of the front camera 11 as its vertex, is defined as follows.

θ̅ [Math. 1]

Further, with the intersection X described above as its vertex, the angle change in the angle formed between the subject 3 and the observed image 4 is defined as follows.

Δθ [Math. 2]

At this time, a distance Y from the optical axis 2 to the subject 3 in the vertical direction can be expressed as follows.

Y=Z tan θ̅ [Math. 3]

In addition, a distance Y1 from the optical axis 2 to the intersection X in the vertical direction can be expressed as follows.

Y1=g_{z} tan θ [Math. 4]

A distance Y2 from the intersection X to a parallel line passing through the subject 3 parallel to the optical axis 2 in the vertical direction can be expressed as follows.

Y2=(Z−g_{z}) tan (θ−Δθ) [Math. 5]

Here, Y1+Y2 is expressed by Equation (1).

[Math. 6]

Y1+Y2=(Z−g_{z}) tan (θ−Δθ)+g_{z} tan θ (1)

In addition, as shown in FIG. 2, Y=Y1+Y2; dividing this equation by the depth Z of the subject and rearranging it yields Equation (2).

$$\begin{matrix}[ Math . 7 ] & \\ tan \overline{θ} = tan ( θ - Δθ ) + \frac{{g}_{z}}{Z} ( tan θ - tan ( θ - Δθ ) ) & ( 2 )\end{matrix}$$

The front camera 11 is provided in the vicinity of the windshield 1, and considering an overhang of the front part of the vehicle for the subject 3, the depth Z of the subject is sufficiently larger than the depth g_{z} of the glass, and the value (g_{z}/Z) becomes a value close to zero. Thus, the term in Equation (2) including the value (g_{z}/Z) also becomes a value close to zero, and as a result, Equation (3) is derived from Equation (2).

[Math. 8]

θ̅≈θ−Δθ (3)

That is, if the depth Z of the subject is sufficiently larger than the depth g_{z}, the field of view (Math. 9) can be approximately obtained from the observed field of view θ and the angle change (Math 10) due to refraction.

θ̅[Math. 9]

Δθ[Math. 10]

Furthermore, if the depth Z of the subject is sufficiently larger than the depth g_{z}, the position of the observed image 4 can be corrected to the position of the subject 3 simply by the observed field of view and the angle change, regardless of the depth Z of the subject. Incidentally, when
Depth Z of subject=3 [m],
Depth g_{z} of glass=0.04 [m],
Observed field of view θ=10 degrees, and

Angle change (Math. 11)=0.5 degrees, the field of view (Math. 12) calculated using Equation (2) becomes 9.5066 degrees.

Δθ [Math. 11]

θ̅ [Math. 12]

The error between this value and the approximate value of the field of view obtained by Equation (3), 9.5 degrees (=10 degrees-0.5 degrees), becomes 0.0066 degrees. If the error in the field of view between an image after correction of the observed field of view with respect to the captured image when the glass is present and a captured image when no glass is present has an accuracy equal to or smaller than a predetermined value, for example, equal to or smaller than 0.1 degrees, it will not cause any problem in applications such as driving assistance systems. Hence, the calibration device 10 sets a position correction function for calibration of the onboard camera and calculates the parameter value for the coordinate correction function on the premise that the depth Z from the camera to a subject is sufficiently larger than the depth g_{z} from the camera to the glass, that is, on the premise that the field of view with respect to the subject 3 can be approximated using the observed field of view with respect to the observed image and the angle change caused by the glass. Here, “coordinates” indicate a pixel position of an image captured within an imaging range of the onboard camera.

Next, a coordinate correction function for calibration will be described. Description will be given on the assumption that the front camera 11 is provided in an upper central portion of the windshield inside the vehicle.

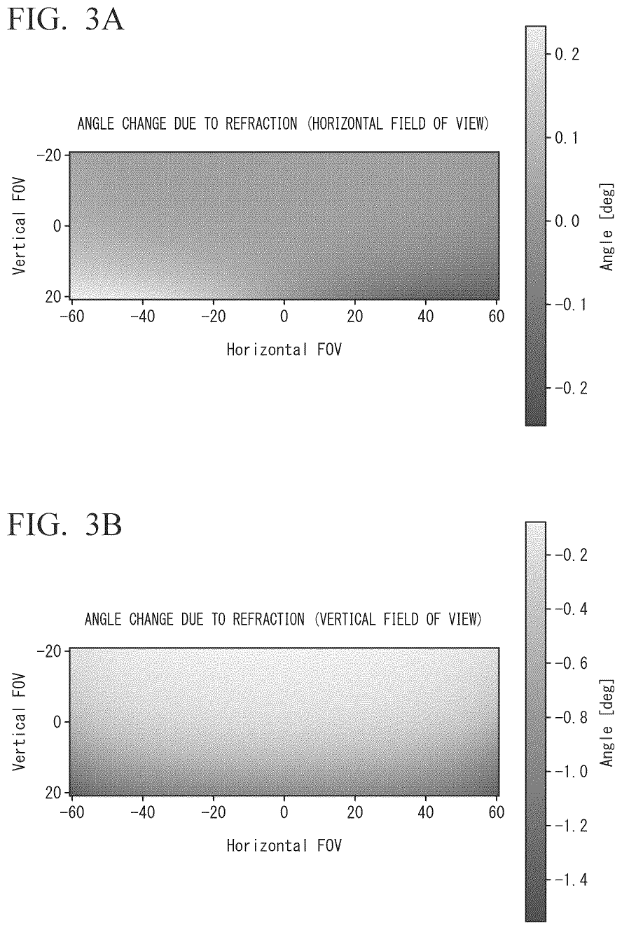

FIGS. 3A and 3B are diagrams showing angle changes due to refraction of light, which are simulated based on a three-dimensional design shape of the windshield. Here, the imaging field of view of the front camera 11 is assumed to be −60 degrees to +60 degrees in the horizontal direction and −20 degrees to +20 degrees in the vertical direction. FIG. 3A is a diagram showing angle changes due to refraction in the horizontal field-of-view direction. FIG. 3B is a diagram showing angle changes due to refraction in the vertical field-of-view direction. When the front camera 11 is provided in the upper central portion of the windshield inside the vehicle, it can be said that the amount of change in curvature of the windshield in the horizontal direction is laterally symmetrical with respect to a perpendicular line from the optical axis of the front camera 11. As can be seen from the relationship between the windshield 1 and the front camera 11 in FIG. 2, as the position moves further downward in a direction perpendicular to the optical axis of the front camera 11, the angle of incidence from the imaging position of the front camera 11 with respect to the surface of the windshield 1 decreases. The smaller the angle of incidence, the greater the influence of refraction of light caused by the windshield 1. Therefore, as shown in FIG. 3A, it can be seen that the angle change in the horizontal field of view due to refraction becomes larger at positions with a wider field of view in the horizontal direction and the field of view in the vertical direction toward the downward direction.

In addition, as shown in FIG. 3B, it can be seen that the angle change in the vertical field of view due to refraction is more affected by the vertical field of view than by the field of view in the horizontal direction, and that the angle change becomes larger as the field of view in the vertical direction moves further downward.

In summary,
1) The angle change in the horizontal field of view due to refraction
   The larger the horizontal field of view, the larger the angle change due to refraction.
   The further downward the vertical field of view, the larger the angle change due to refraction.
   The direction (positive or negative) of the angle change due to refraction changes depending on whether the horizontal field of view is positive or negative.
2) The angle change in the vertical field of view due to refraction
   The influence of changes in the vertical field of view is greater than that of changes in the horizontal field of view.
   The direction of the angle change due to refraction does not change depending on whether the horizontal field of view is positive or negative.

Hence, a coordinate correction function is set for calibration which can effectively correct the angle change due to refraction in the horizontal field of view and the vertical field of view described above. When the observed field of view in the horizontal direction is φ and the observed field of view in the vertical direction is θ, the coordinate position on the image based on the field of view is expressed as in Equation (4).

[Math. 13]

x=tan (φ), y=tan (θ) (horizontal field of view φ and vertical field of view θ) (4)

When the field of view in the horizontal direction when no windshield is present is defined as follows,

φ̅ [Math. 14]

and when the field-of-view in the vertical direction is defined as follows,

θ̅[Math. 15]

the coordinate position on the image based on the field of view when no windshield is present is expressed as in Equation (5).

[Math. 16]

x̅=tan(φ̅), γ̅=tan(θ̅) (horizontal field of view φ and vertical field of view θ when no glass is present)

Hence, the correction amount of the coordinates for correcting the influence of refraction of light caused by the windshield is defined as in Equation (6).

$$\begin{matrix}[ Math . 17 ] & \\ \begin{matrix}Correction amount \\ of coordinates\end{matrix} : ( \begin{matrix}\overline{x} - x \\ \overline{y} - y\end{matrix} ) = ( \begin{matrix}{A}_{1} ( y ) {x}^{3} + {A}_{2} ( y ) x \\ {A}_{3} ( y ) {x}^{4} + {A}_{4} ( y ) {x}^{2} + {A}_{5} ( y )\end{matrix} ) & ( 6 )\end{matrix}$$

Equation (6) is an equation in which the horizontal field of view and the vertical field of view are reformulated in terms of the coordinate positions in the horizontal direction and the vertical direction, and is an example of the coordinate correction function for calibration which corrects the coordinate positions for the angle changes due to refraction at the coordinate position in the horizontal direction and the vertical direction. The coordinate origins for horizontal field of view and the vertical field of view are assumed to coincide with the coordinate origins in the horizontal direction and the vertical direction.

That is, Equation (6) is a function which can have the following features.
1) The pixel position correction amount due to refraction in the horizontal direction (x direction)
   The further the pixel position is away from the origin in the horizontal direction, the greater the pixel position correction due to refraction.
   The pixel position correction due to refraction increases as the pixel position moves further downward in the vertical direction.
   The direction of pixel position correction due to refraction changes depending on whether the pixel position in the horizontal direction is positive or negative.
2) The pixel position correction amount due to refraction in the vertical direction (y direction)
   The pixel position correction due to change in the pixel position in the vertical direction is made larger than the difference in the pixel position in the horizontal direction.
   The direction of pixel position correction due to refraction does not change depending on whether the pixel position in the horizontal direction is positive or negative.

Equation (6) will be described as an example of a pixel correction function which can perform the foregoing correction.
1) Regarding the coordinate correction function equation (6-1) in the horizontal direction (x direction),
   Correction amount of coordinates in x direction:

(x̅−x)=(A₁(y)x³A₂(y)x) [Math 18](6−1)

the coordinate correction amount in the x direction is expressed as a cubic equation with respect to the variable x. This is because the value increases as the coordinate position in the x direction moves away from the origin, and the direction (positive or negative) of the correction amount of the coordinates in the x direction changes depending on whether the coordinate position in the x direction is positive or negative.
2) Regarding the coordinate correction function equation (6-2) in the vertical direction (y direction),
   Correction amount of coordinates in y direction:

(y̅−y)=(A₃(y)x⁴+A₄(y)x²+A₅(y) [Math 19](6−2)

the coordinate correction amount in the y direction is expressed as a quartic equation with respect to the variable x. This is to prevent the direction (positive or negative) of the correction amount of the coordinates in the y direction from changing depending on whether the coordinate position in the x direction is positive or negative.

Equations (7) show functions A₁(y) to A₅(y) with y in Equation (6) as a variable.

### [Math. 20]

$${A}_{1} ( y ) = - {( {a}_{1} y + {a}_{2} )}^{2} - {( {a}_{3} )}^{2} {A}_{2} ( y ) = - {( {a}_{4} y + {a}_{5} )}^{2} - {( {a}_{6} )}^{2} {A}_{3} ( y ) = {a}_{7} {y}^{2} + {a}_{8} y + {a}_{9} {A}_{4} ( y ) = {a}_{10} {y}^{2} + {a}_{11} y + {a}_{12} {A}_{5} ( y ) = {a}_{13} {y}^{2} + {a}_{14} y \qquad ( 7 )$$

The parameter values a₁ to a₁₄ in Equations (7) are fixed coefficients. In Equations (7), A₁(y) and A₂(y) related to the coordinate correction amount in the x direction are expressed as linear equations of y, and A₃(y) to A₅(y) related to the coordinate correction amount in the y direction are expressed as quadratic equations of y. This is because the coordinate correction amount in the y direction is more significantly affected by the differences in the coordinate position in the y direction than the coordinate correction amount in the x direction.

The parameter values a₁ to a₁₄ in Equations (7) are fixed coefficients. The parameter values a₁ to a₁₄ are determined based on the pixel correction amount obtained from distortion of an image due to refraction of light at the glass in the horizontal direction (x direction) and the vertical direction (y direction) obtained from an image of the calibration board captured by the onboard camera. That is, utilizing the pixel position correction amount due to refraction obtained from a captured image of the calibration board, the parameter values a₁ to a₁₄ in Equations (7) are determined such that the squared error is minimized when Equations (6) and (7) are used.

Equations (6) and (7) showing the coordinate correction functions are merely examples and are not limited thereto. The coordinate correction functions may be any function which can effectively correct the horizontal field of view determined by the positional relationship between the onboard camera and the glass in front of it, and the shape of the glass; and the angle change due to refraction in the horizontal field of view, when the depth from the onboard camera to a subject is sufficiently larger than the depth from the onboard camera to the glass.

The onboard camera stores the parameter values a₁ to a₁₄ obtained by the calibration device 10 as the parameters of the coordinate correction functions. Further, the onboard camera generates an output image in which the influence of refraction of light caused by the glass is eliminated by performing pixel position correction of the captured image based on the stored parameters and the coordinate correction functions used by the calibration device 10.

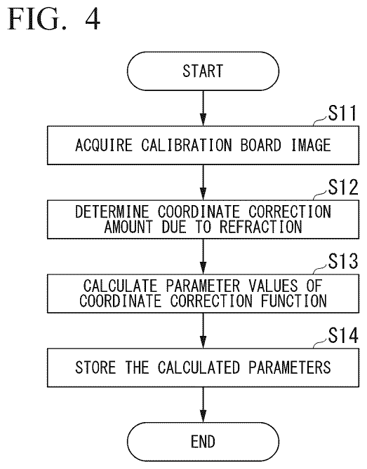

Next, operation of the calibration device 10 will be described. FIG. 4 is a diagram showing operation of the calibration device 10.

The image acquisition part 121a of the calibration device 10 acquires an image of an imaging object installed outside the vehicle using the front camera 11 (Step S11). Here, the “imaging object” may be any object as long as the coordinate correction amount can be determined from the image. However, a calibration board is preferable. A “calibration board” is a board for measuring the correction amount of the coordinates due to refraction in the horizontal direction and the vertical direction at each position of the image in the imaging range of the front camera 11. The calibration board is a board having a regular geometric pattern making it easy to determine the pixel position correction amounts of the respective coordinates. For example, the calibration board is a board having a checkerboard pattern in which square regions of the same size but different colors, for example, white and black squares, are alternately arranged. The contact points and linear portions of the white and black squares are used as feature points, and the pixel position correction amounts of the respective coordinates in a captured image are determined based on distortion of these feature points.

The coordinate correction amount determination part 121b of the calibration device 10 determines the correction amount of the coordinates at each pixel position from a captured image of the calibration board (Step S12). The captured image of the calibration board becomes an image with distortion due to refraction of light caused by the windshield 1. When the windshield 1 is not present, a captured image of the front camera 11 becomes an image which matches the pattern applied to the calibration board. Hence, the coordinate correction amount determination part 121b determines, as the correction amount, the difference between the pixel positions (coordinates) in the horizontal direction and the vertical direction when each pixel position of the captured image of the calibration board is corrected to that in an image with no distortion.

The parameter calculation part 121c of the calibration device 10 calculates the parameter values of the coordinate correction functions, which have been set in advance, using each pixel position correction amount determined by the coordinate correction amount determination part 121b (Step S13). For example, the parameter calculation part 121c calculates the parameter values a₁ to a₁₄ such that the squared error with respect to each pixel position correction amount is minimized using the pixel correction functions as in Equations (6) and (7).

In addition, the parameter calculation part 121c stores the calculated parameter values in the memory 120 (Step S14).

As described above, the calibration device 10 obtains the parameter values for eliminating distortion due to refraction of light caused by the windshield 1 from the captured image of the front camera 11.

Even if both the onboard camera and the glass in front of the onboard camera are manufactured under the same design and the positional relationship between the onboard camera and the glass is intended to be identical, manufacturing tolerances can still occur in the onboard camera and the windshield. Further, an error may also occur in the positional relationship between the onboard camera and the glass. Hence, the calibration device 10 may acquire captured images of the calibration board using a plurality of sets each including an onboard camera of the same kind and a windshield of the same kind, determine the coordinate correction amounts from the captured images obtained from the respective sets, and determine the parameter values using the coordinate correction amounts. In this manner, using a plurality of images of the calibration board obtained from the sets including an onboard camera of the same kind and a windshield of the same kind, it is possible to enhance the robustness of correction for captured images in vehicles using an onboard camera of the same kind and a windshield of the same kind.

Incidentally, the same vehicle model usually uses the same kind of onboard camera and glass, and the positional relationship between the onboard camera and the glass is also the same. Thus, the calibration device 10 can also obtain the parameters of the coordinate correction function for each vehicle model by performing the processing shown in FIG. 4 for each vehicle model.

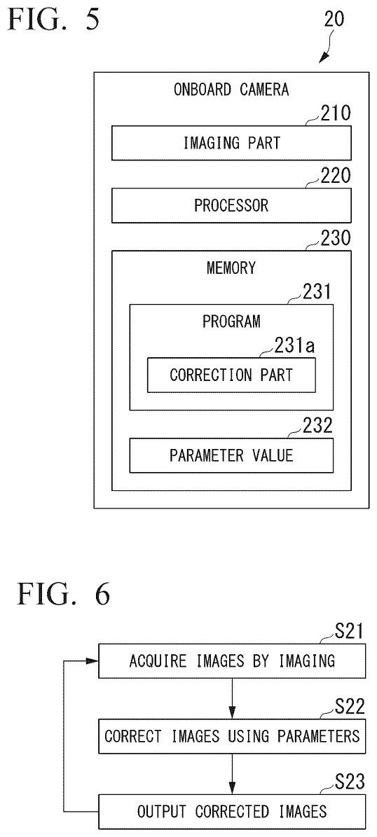

Next, an onboard camera performing correction of a captured image using parameters obtained by the calibration device 10 will be described. FIG. 5 is a diagram showing an example of a configuration of an onboard camera performing distortion correction of a captured image using parameters obtained by the calibration device 10. An onboard camera 20 is constituted of an imaging part 210, a processor 220, and a memory 230. The memory 230 stores a program 231 and a parameter value 232 obtained by the calibration device 10. The processor 220 executes the program 231 to realize the function of outputting an image in which distortion of a captured image has been corrected, using the stored parameter value 232. When the program 231 is executed by the processor 220, the function as a correction part 231a is realized. Here, the correction part 231a performs pixel position correction of a captured image using information for coordinate position correction for distortion correction of a captured image. The onboard camera 20 is an example of an “onboard device”. The functional configurations different from those of the imaging part 210 included in the onboard camera 20 may be mounted in an onboard device different from the onboard camera 20, and the onboard device may perform processing utilizing the parameter values.

Next, operation of the onboard camera 20 will be described. FIG. 6 is a diagram showing operation the onboard camera 20 correcting distortion of a captured image. The onboard camera 20 acquires a captured image using the imaging part 210 (Step S21).

The correction part 231a of the onboard camera 20 corrects a captured image using the coordinate correction functions used when the calibration device 10 calculates the parameter value 232, and the parameter value 232 stored in the memory 230 (Step S22). In this processing, the correction part 231a sets the parameter values as the values of the coefficients a₁ to a₁₄ in Equations (7) and obtains the coordinate position (Math. 21) when no distortion is present in each pixel position (x, y).

(x̅,y̅) [Math. 21]

Further, the correction part 231a corrects a captured image by correcting the pixel value at the pixel position (x, y) to the value of the obtained coordinate position (Math. 22).

The coordinate position after correction may not be the center of the pixel. In such a case, image correction may be performed by allocating the pixel values corresponding to the coordinate position after correction to several pixels in the vicinity of the coordinate position after correction.

The correction part 231a outputs the corrected image to a device which utilizes the corrected image (Step S23).

The onboard camera 20 sequentially repeats the processing of Steps S21 to S23 for the captured image. Before starting imaging, the onboard camera 20 may create a pixel position conversion table in which the coordinate positions (Math. 23) when no distortion is present is associated with each pixel position (x, y) using the coordinate correction function and the parameter value 232.

(x̅,y̅) [Math. 23]

In this case, in Step S22, the correction part 231a of the onboard camera 20 performs distortion correction on the captured image using the created pixel position conversion table.

In addition, when the same kind of onboard camera 20 is used across a plurality of vehicle models or variations of glass, the onboard camera 20 may store the parameter value 232 for each vehicle model or for each glass type used so as to perform distortion correction of a captured image corresponding to the model and the variations of glass. In this case, a target glass is identified by initial value setting for the onboard camera 20 or information from other devices inside the vehicle.

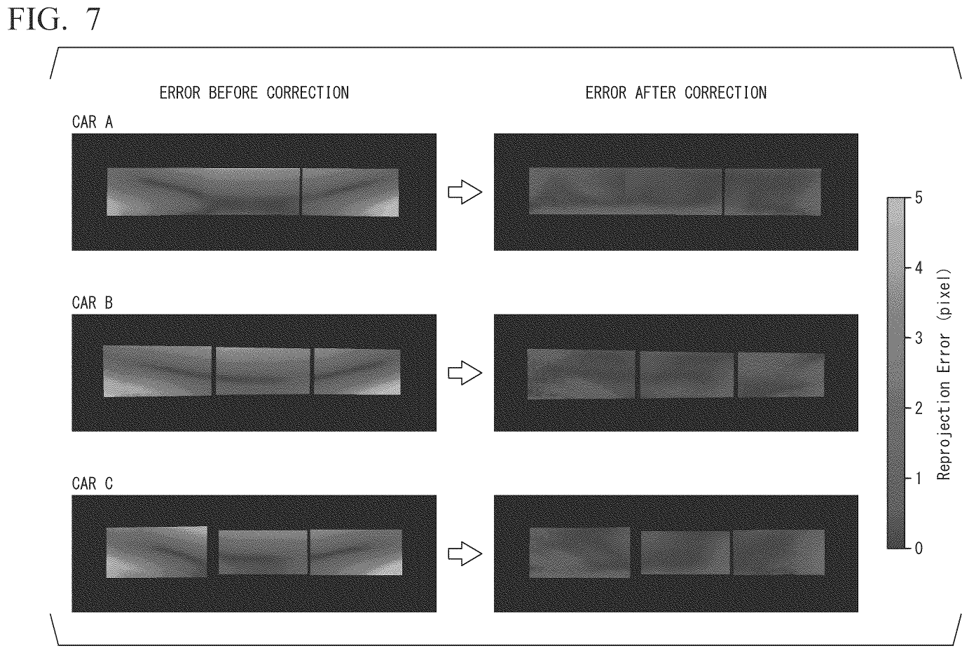

FIG. 7 is a diagram showing amounts of pixel position error before and after correction in the onboard camera provided in a different vehicle of the same vehicle model. In FIG. 7, distortion of an image is measured for these vehicles, and the parameter values are determined using the measurement results. As shown in FIG. 7, it has been confirmed that a corrected image in which distortion is eliminated from the captured image can be generated based on the actual measurement results of the onboard cameras mounted in the respective vehicles.

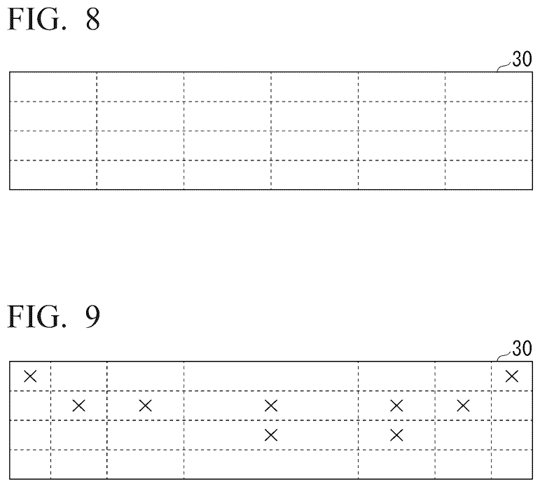

In the present embodiment, the calibration device 10 has been described as obtaining one set of parameters for a coordinate correction function targeted on the entire imaging range of the onboard camera, but the present invention is not limited to this. For example, as shown in FIG. 8, by dividing an imaging range 30 of the onboard camera into several blocks, the parameter calculation part 121c of the calibration device 10 may obtain the parameters of the coordinate correction function for each block. In this case, the onboard camera 20 stores the parameters for each block, and the correction part 231a of the onboard camera 20 corrects the coordinate position using the parameter value corresponding to the divided block.

In addition, the division of the imaging range of the onboard camera is not limited to division into blocks of the same size as in the example shown in FIG. 8. For example, as shown in FIG. 9, the imaging range 30 of the onboard camera may be divided into blocks of different sizes. At this time, in order to enhance the correction accuracy, as shown in FIGS. 3A and 3B, it is preferable to determine the division blocks so as to minutely divide the blocks in areas where the angle change (change in coordinate position) due to refraction is large.

In addition, the coordinate correction amount determination part 121b of the calibration device 10 may provide a flag indicating that coordinate correction of pixels in a block divided as in FIGS. 8 and 9 does not need to be performed when the coordinate correction amounts of all pixels included in the block are equal to or smaller than a predetermined value. Further, the flag value may be stored in association with the division block. Here, for example, regarding the predetermined value, the coordinate correction amount is set to 0.5 or smaller (0.5 pixels or less). The factor “x” in FIG. 9 indicates an example of a block provided with this flag.

In this case, the onboard camera 20 also stores flag information on the division blocks in the memory 230. Further, the correction part 231a of the onboard camera 20 does not perform coordinate position correction for pixels within the blocks provided with a flag. Accordingly, the onboard camera 20 can reduce the amount of processing for distortion correction of a captured image.

In addition, in the present embodiment, an example in which an onboard camera and a glass in front of the onboard camera are respectively referred to as a “front camera” and a “windshield” has been described, but the present invention is not limited to this. For example, the technology described in the present embodiment can also be applied to a set of a rear camera and a rear glass. Further, in the relationship between the camera and the glass which has been described so far, when the depth from the camera to a subject is sufficiently larger than the depth from the camera to the glass, the technology of the calibration device 10 and the onboard camera 20 described in the present embodiment can be applied not only to the camera and the glass provided in a vehicle.

In the present embodiment, a “glass” has been described as a laminated glass or a tempered glass used in vehicles, such as windshields and rear glasses. However, a “glass” is not limited to this and may include a so-called ordinary glass mainly composed of silica. Further, a “glass” may also include objects, for example, polycarbonate or acrylic plates, allowing light to be transmitted through and allowing the outside to be observed.

As above, the calibration device according to the present embodiment sets the coordinate correction function for correcting distortion of a captured image caused by the glass on the premise that the depth from the onboard camera to a subject is sufficiently larger than the depth from the onboard camera to the glass, and calculates the parameters for correcting an image captured by the onboard camera utilizing an image of the calibration board. Further, the onboard camera corrects a captured image using the coordinate correction function and the parameters used in the calibration device. In this manner, the onboard camera can correct a captured image using only the coordinate correction function and the determined parameters.

In addition, when the combination and the positional relationship of the onboard camera and the glass are the same, the captured image can be corrected using the same parameter values for each onboard camera. Thus, individual calibration processing does not have to be performed for the onboard camera in each vehicle.

Further, in the case of a combination of different variations of glass with the same kind of onboard camera, parameters for correcting glass distortion for each variation may be stored for the same kind of onboard camera. Accordingly, the onboard camera can perform distortion correction of a captured image for different variations of glass by simply performing setting of identifying which glass combination the onboard camera is compatible with. For example, a driving assistance device of a vehicle can perform automated driving or driving assistance by utilizing the corrected image for object recognition, road structure recognition, and the like, thereby making it possible to realize control which is more appropriately adapted to the surrounding conditions.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

### EXPLANATION OF REFERENCES

1 Windshield
2 Optical axis
3 Subject
4 Observed image
11 Front camera
20 Onboard camera
100 Processor
120 Memory
121 Program
121a Image acquisition part
121b Coordinate correction amount determination part
121c Parameter calculation part
122 Parameter value
210 Imaging part
220 Processor
230 Memory
231 Program
231a Correction part
232 Parameter value

What is claimed is:

1. An onboard camera calibration device comprising:
an image acquisition part acquiring an image, of an imaging object for measuring a correction amount of a captured image, captured by a camera provided behind a glass; and
a parameter calculation part calculating, based on an acquired image of the imaging object, a parameter value of a coordinate correction function for correcting an image captured by the camera, in which the coordinate correction function is set on the premise that a depth from the camera to a subject is sufficiently larger than a depth from the camera to the glass.

2. The onboard camera calibration device according to claim 1,
wherein in a case where a field of view from the camera to a subject when the glass is not present is able to be approximated by an angle obtained by subtracting an angle change due to refraction of light at the glass from an observed field of view of the subject from the camera, the depth from the camera to a subject is sufficiently larger than the depth from the camera to the glass.

3. The onboard camera calibration device according to claim 2,
wherein when a difference in angle obtained by subtracting the angle change from the observed field of view with respect to the field of view is equal to or smaller than a predetermined value, the field of view from the camera to a subject when the glass is not present is able to be approximated by an angle obtained by subtracting an angle change due to refraction caused by the glass from an observed angle of the subject by the camera.

4. The onboard camera calibration device according to claim 1, further comprising:
a coordinate correction amount determination part determining a pixel position correction amount due to refraction at the glass using an image of the imaging object,
wherein the parameter calculation part calculates a parameter value of the coordinate correction function using the pixel position correction amount.

5. The onboard camera calibration device according to claim 4,
wherein the coordinate correction function is set for each of a horizontal direction and a vertical direction, and
the parameter calculation part obtains a parameter value of the coordinate correction function set in advance for each of the horizontal direction and the vertical direction.

6. The onboard camera calibration device according to claim 4,
wherein the parameter calculation part calculates a parameter value of the coordinate correction function common to the entire imaging range of the camera.

7. The onboard camera calibration device according to claim 4,
wherein the parameter calculation part calculates a parameter value of the coordinate correction function for each of a plurality of regions obtained by dividing the entire imaging range of the camera.

8. The onboard camera calibration device according to claim 7,
wherein when the correction amount is equal to or smaller than a predetermined value for all pixels within any one of the plurality of regions obtained by dividing the entire imaging range of the camera, the parameter calculation part performs processing such that pixel position correction in the region is unnecessary.

9. The onboard camera calibration device according to claim 1,
wherein the imaging object is a calibration board having a regular geometric pattern.

10. An onboard device comprising:
a storage part storing information for coordinate position correction of a captured image calculated by the onboard camera calibration device according to claim 1; and
a correction part performing pixel position correction of a captured image using the information for coordinate position correction.

11. The onboard device according to claim 10,
wherein the information for coordinate position correction includes a parameter value for a coordinate correction function calculated by the onboard camera calibration device, and
the correction part corrects a pixel position of a captured image using the coordinate correction function and the parameter value.

12. The onboard device according to claim 10,
wherein the storage part includes a plurality of pieces of the information for coordinate position correction, and
the correction part performs pixel position correction of a captured image using the information for coordinate position correction corresponding to a glass provided in front of an onboard camera installed inside a vehicle.

13. An onboard device comprising:
a storage part storing a parameter value of a coordinate correction function for correcting an image of scenery captured by a camera through a glass provided in a vehicle to an image of scenery captured by the camera without having the glass therebetween, in which the coordinate correction function is set on the premise that a depth from the camera to a subject is sufficiently larger than a depth from the camera to the glass; and
a correction part correcting an image captured by the camera based on the stored parameter value.

14. A method for calibrating an onboard camera comprising:
acquiring an image, of an imaging object for measuring a correction amount of a captured image, captured by a camera provided behind a glass; and
calculating, based on an acquired image of the imaging object, a parameter value of a coordinate correction function for correcting an image captured by the camera, in which the coordinate correction function is set on the premise that a depth from the camera to a subject is sufficiently larger than a depth from the camera to the glass.

15. An onboard camera calibration program for causing a computer to execute:
acquiring an image, of an imaging object for measuring a correction amount of a captured image, captured by a camera provided behind a glass; and
calculating, based on an acquired image of the imaging object, a parameter value of a coordinate correction function for correcting an image captured by the camera, in which the coordinate correction function is set on the premise that a depth from the camera to a subject is sufficiently larger than a depth from the camera to the glass.
